(19) United States
(12) Patent Application Publication
(10) Pub. No.: US 2006/0200278 A1
(43) Pub. Date: Sep. 7, 2006

(54) Generic software fault mitigation

(75) Inventor: Martin W. Feintuch, Montville, NJ (US)

Correspondence Address: Honeywell International Inc.;Law Department. AB2, Post Office Box 2245, Morristown, NJ, 07962-2245, US

(73) Assignee: Honeywell International Inc., Morristown, NJ (US)

(21) Appl. No.: 11/070,018

(22) Filed: Mar. 2, 2005

(51) Int. Cl. G06F 7/00

(52) U.S. Cl. 701/3; 701/1

(57) ABSTRACT

A flight control computer system includes a plurality of computing channels (11, 21, and 31) where each computing channel further includes a main processor (113) and a monitor processor (114) under control of distinct operating systems. When the main processor and the monitor processor miscompare, cross-channel failure discretes (131) are transmitted to the other computing channels and a local generic fault discrete is armed. When the local generic fault discrete is armed and cross-channel failure discretes (141, 142) are received from the other computing channels, a program interrupt (133) is issued causing the main processor to execute a minimal fully tested ‘get home’ software package (150).

### BACKGROUND OF THE INVENTION

1. Technical Field

This invention relates to the field of software fault mitigation and more specifically to methods of recovering a software generic fault in a flight control system.

2. Background Art

Any discussion of the prior art throughout the specification should in no way be considered as an admission that such prior art is widely known or forms part of common general knowledge in the field.

It is known in the field of redundant flight computing to run three flight control computers in parallel so that either the failure of a first or a first and second computer does not cause a catastrophic failure, such as the loss of an aircraft. Within each of these computers, there is typically a set of processors that run in parallel such that an erroneous output signal is not produced. In the art, the redundant computers are referred to as ‘channels’ and the number of processors and associated redundant input/ output circuitry within each computer are referred to as ‘lanes’.

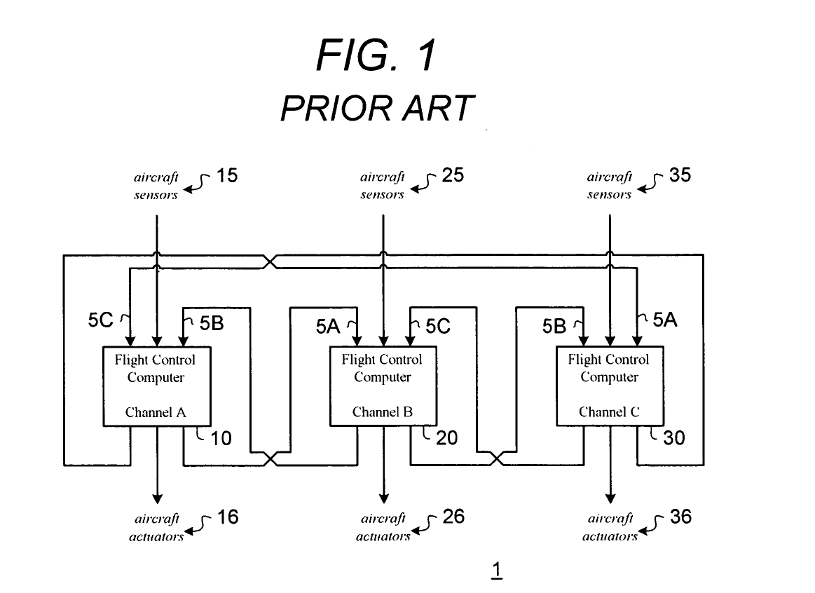

FIG. 1 illustrates such a three channel flight control computer as might be employed on a modern ‘fly by wire’ airplane. In this particular example, flight control computer channel A 10 receives inputs from a first set of aircraft sensors 15, processes these inputs, and produces outputs to drive a first set of aircraft actuators 16. In a similar manner, a second set of aircraft sensors 25 is processed by flight control computer channel B 20, producing outputs to drive a second set of aircraft actuators 26. A third set of aircraft sensors 35 is processed by flight control computer channel C 30, producing outputs to drive a third set of aircraft actuators 36. Within each of the flight control computer channels 10, 20, and 30 dissimilar processors run in parallel, using the same inputs, running dissimilar code with similar functionality, and normally generating the same outputs. When one of the processors within a flight control computer channel generates an output that does not agree with other processors within that same channel, then the channel is ‘voted out’ and not used to provide aircraft actuator outputs.

It is also known to interconnect the several computers in a multiple computer system with a set of ‘cross-channel data links’ 5A, 5B, and 5C, where these data links allow each of the computer channels 10, 20, and 30 to share data with all of the computer channels. As shown, the cross-channel from channel A 5A provides data contained within computing channel A 10 to both computing channel B 20 and computing channel C 30. The cross-channel data links, 5B and 5C, from computing channels B and C respectively function in a similar manner.

A major concern in the implementation of redundant computational systems is the occurrence of generic faults. This class of failure could, with a single fault, disable an entire system if the system included only two processors per channel, because the fault would be common in all channels. This generic failure could be either a ‘design fault’ or a ‘manufacturing fault’. A design fault can occur in either hardware or software. A manufacturing fault is where a particular batch of hardware or a particular release of software includes an inherent defect. The design for a typical system is validated by performing hardware simulations at extreme tolerances and by qualification tests performed on prototype hardware. Hardware manufacturing faults are detected by acceptance test procedures (ATP) that validate that the produced article is as designed.

Extensive and exhaustive testing of the particular source code for a typical system validates the software design. This software testing may be executed on the target hardware or on an emulation of that hardware. An alternate validation approach that has proven to be extremely expensive is where a second software team develops a package for real-time comparison on the target hardware.

The software development environment (autocode mechanisms, compilers, assemblers, loaders, etc) can introduce software “manufacturing” faults. Extensive testing of the software on the target hardware may not be sufficient to detect all faults as some data dependent combinatorial paths may be missed.

During operation of a flight control computer, a generic software fault can manifest itself in two different ways. The first way is where the operational flight program (OFP) software in all channels “gets lost” and there is a total loss of the system. The second way is where the OFP in all channels produces an erroneous output but the system continues to appear to operate normally because no miscomparisons have occurred between channels. Either scenario should be detected by extensive testing of the binary code on the target hardware. However, if sufficient testing is not performed the generic fault could occur and lead to a potentially hazardous condition.

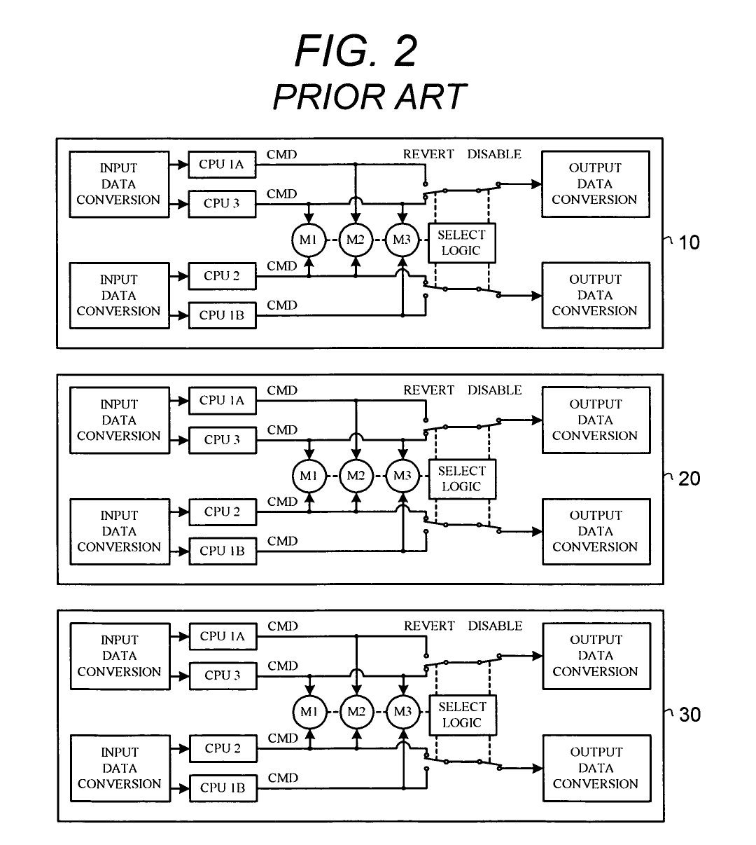

The art has progressed to the point where both dissimilar processors and dissimilar software are used in each flight control computer lane. A leading example of this approach is described in Hay (U.S. Pat. No. 5,550,736) which shows a monitoring method for a fail-operational fault tolerant flight critical computer architecture. Such an architecture, for three redundant computing channels, is shown in FIG. 2. As shown in FIG. 2, each computing channel 10, 20, and 30 includes dual independent lanes with two processors or CPUs in each lane. The first lane includes a first primary processor (CPU 3) and a first redundant processor (CPU 1A) and the second lane includes a second primary processor (CPU 2) and a second redundant processor (CPU 1 B). Each of the processors provides an output signal in response to signals from one or more sensors representative of characteristics concerning an aircraft. The outputs of the first and second primary processors are monitored (M1) with respect to each other and first comparison signals representative thereof are generated. The outputs of the first redundant processor and the second primary processor are monitored (M2) with respect to each other and second comparison signals representative thereof are generated. The outputs of the second redundant processor and the first primary processor are monitored (M3) with respect to each other and third comparison signals representative thereof are generated. At least one of the output signals of the processors is selected as at least one command signal for the aircraft as a function of the first, second and third comparison signals.

Accordingly the method and architecture according to Hay require at least three different processor types, such as from different processor families. However, only two processor families, the x486 processor and the PowerPC® are currently experiencing sufficient commercial success to ensure technical currency and development. It does not appear that a third processor family will be developed and enjoy large production numbers.

The present mitigation method for a triplex channel dual processor lane architecture that ‘gets lost’ is to sense the simultaneous lost situation in all three channels based on, for example, a simultaneous loss of three watchdog timers and a resultant restart of a computational frame in each channel. This method allows the processing to recover from a specific “gets lost” scenario, but does not address an erroneous calculation scenario nor does it protect against the recurrence of a generic “gets lost” failure. The present mitigation method, for the erroneous calculation failure mode, is to have a different type processor (e.g. Pentium vs. Power PC) monitor the main processor. This monitor processor would use the same source code as the main processor, but since the development environment is different, failures in that environment would be detected in the real-time application. Unfortunately, the failure would be detected simultaneously in all three channels of a triplex channel system, and the embedded redundancy management scheme would drop the entire system. This situation has been mitigated in the past by the introduction of a third dissimilar processor as discussed previously. If two of the three processors were to disagree, this third processor would control the system.

There is therefore a need for a fault tolerant computer architecture based on two rather than three distinct processor types.

There is a long felt need for detecting a simultaneous fault in a system that includes two or more processors.

### SUMMARY OF THE INVENTION

The following summary of the invention is provided to facilitate an understanding of some of the innovative features unique to the present invention. A full appreciation of the various aspects of the invention can only be gained by taking the entire specification, claims, drawings, and abstract as a whole.

The present invention is advantageously used with multi-computer real-time systems such as aircraft flight control systems. According to an aspect of my invention, the occurrence of a simultaneous fault will cause each channel of the system to revert to a “Get Home” mode. The “Get Home” mode is a software package that is comprised of a minimal simplistic Operational Flight Program (OFP) that is capable of getting the aircraft home. This package would have been 100% tested, such as by deterministic mathematical methods, on the target hardware and is guaranteed to have no generic software or generic hardware faults.

Accordingly, my invention involves a system and a method of using two dissimilar processors with detection of simultaneous fault causing reversion to a minimal complexity 100% tested backup operational mode.

My invention seeks to overcome or at least ameliorate one or more of several problems, including but not limited to: providing a minimal fly home capability for a fly by wire aircraft after a generic software fault. Further, as used in a multi-channel computer system for an airplane, my invention reduces the number of processors as compared to prior flight control computer systems.

Further advantages and embodiments of the present invention will become apparent from the following description and drawings.

### BRIEF DESCRIPTION OF DRAWINGS

The accompanying figures further illustrate the present invention.

### BRIEF DESCRIPTION OF THE SEVERAL VIEWS OF THE DRAWING

FIG. 1 depicts a three-channel computer system, such as that used in a prior art fly-by-wire flight control system.

FIG. 2 provides further details of the prior art flight computer system of FIG. 1.

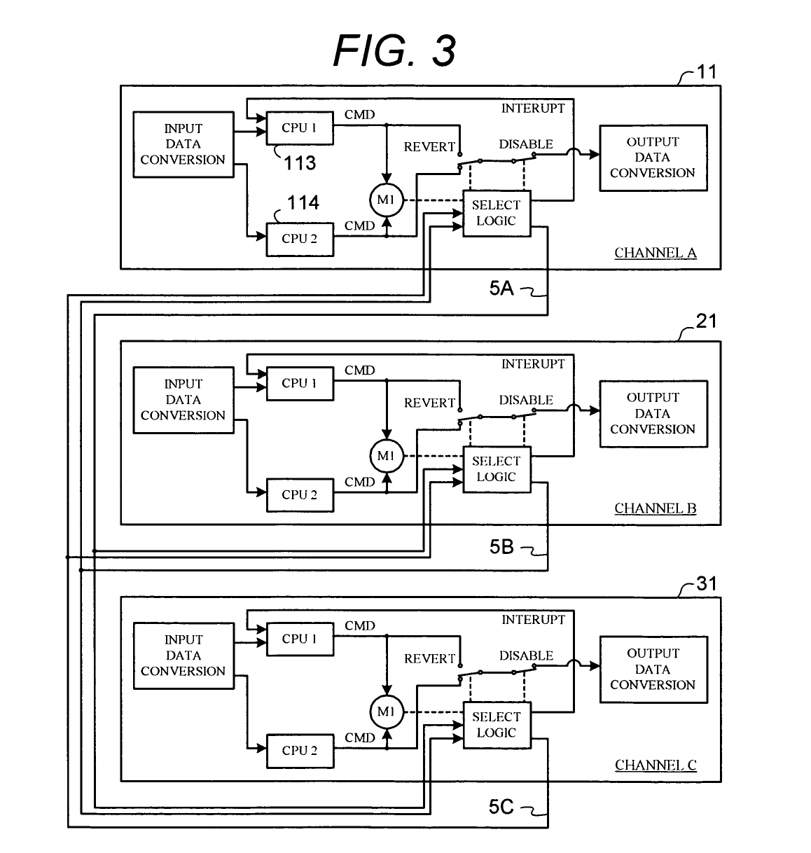

FIG. 3. illustrates certain details of a three-channel computer system in accordance with one illustrative embodiment of the present invention.

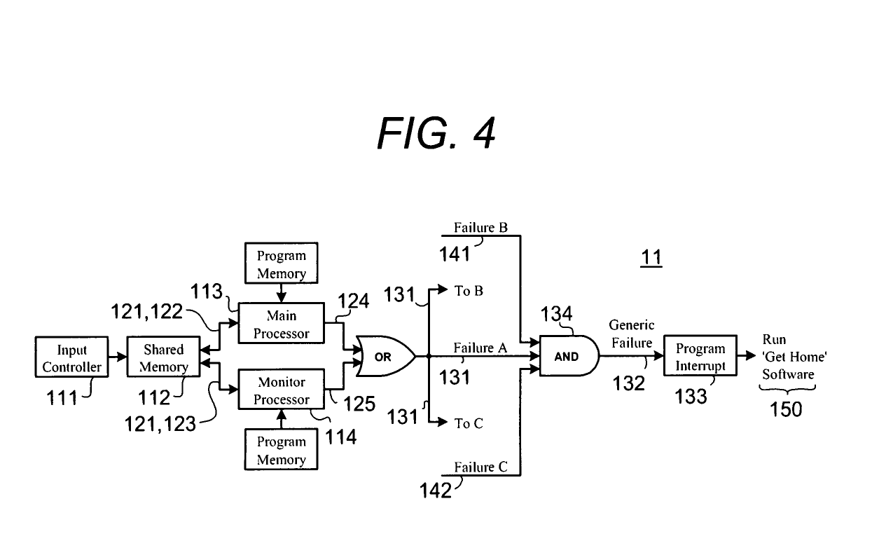

FIG. 4 is a logical block diagram that represents a hardware implementation for generic failure mitigation, in accordance with the illustrative embodiment of my invention depicted in FIG. 3.

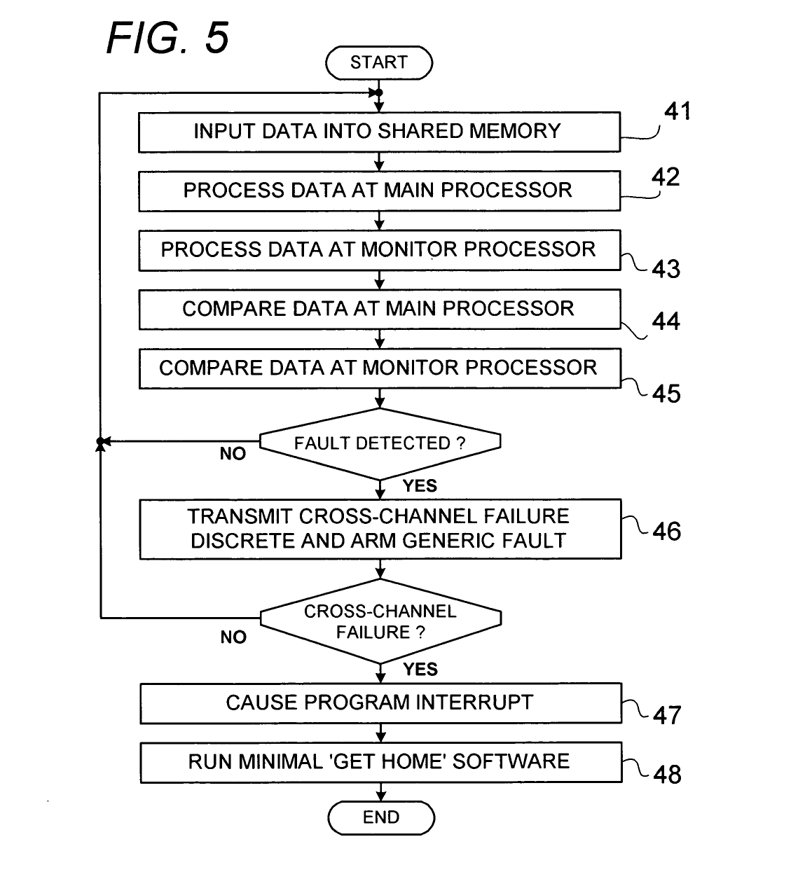

FIG. 5 depicts a method of mitigating generic software failures, in accordance with the illustrative embodiment of my invention depicted in FIGS. 3 and 4.

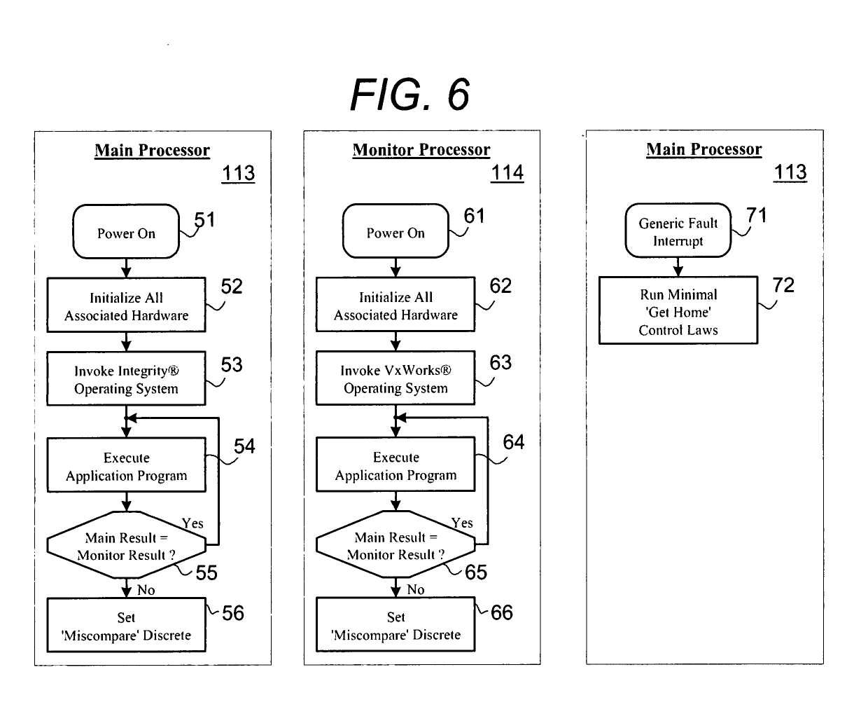

FIG. 6 depicts a software flowchart further illustrating the method of FIG. 3.

### LIST OF REFERENCE NUMBERS FOR THE MAJOR ELEMENTS IN THE DRAWING

The following is a list of the major elements in the drawings in numerical
1 three channel computer system
5A cross-channel data link (from channel A)
5B cross-channel data link (from channel B)
5C cross-channel data link (from channel C)
10 computing channel A (flight control computer)
11 computing channel A (inventive flight control computer)
15 aircraft sensors (channel A)
16 aircraft actuators (channel A)
20 computing channel B (flight control computer)
21 computing channel B (inventive flight control computer)
25 aircraft sensors (channel B)
26 aircraft actuators (channel B)
30 computing channel C (flight control computer)
31 computing channel C (inventive flight control computer)
35 aircraft sensors (channel C)
36 aircraft actuators (channel C)
41 step of inputting data into shared memory
42 step of processing data at main processor
43 step of processing data at monitor processor
44 step of comparing data at main processor
45 step of comparing data at monitor processor
46 step of transmitting cross-channel failure discrete
47 step of causing program interrupt
48 step of running minimal ‘get home’ software
51 step of powering on (main processor)
52 step of initializing hardware (main processor)
53 step of invoking operating system (main processor)
54 step of executing application program (main processor)
55 step of comparing results (main processor)
56 step of setting miscompare discrete (monitor processor)
61 step of powering on (monitor processor)
62 step of initializing hardware (monitor processor)
63 step of invoking operating system (monitor processor)
64 step of executing application program (monitor processor)
65 step of comparing results (monitor processor)
66 step of setting miscompare discrete (monitor processor)
71 step of responding to a generic fault interrupt (main processor
72 step of running minimal ‘get home’ control laws
111 input controller
112 shared memory
113 main processor (CPU 1)
114 monitor processor (CPU 2)
121 inputs (from shared memory)
122 output data (from main processor)
123 output data (from monitor processor)
124 main processor (CPU 1) miscompare discrete
125 monitor processor (CPU 2) miscompare discrete
131 local generic failure discrete (“Failure A”)
132 generic failure discrete (all channels)
133 program interrupt (to main processor)
141 cross-channel failure discrete (to computing channel B)
142 cross-channel failure discrete (to computing channel C)
150 ‘get home’ software (minimal control laws)

### DESCRIPTION OF THE INVENTION

Carrying Out the Invention

FIG. 3 shows a three-channel real-time computing system with two processors per channel in accordance with one specific embodiment of my invention and which may be referenced against a prior art system having similar functionality, such as the system shown in FIG. 2.

Each of the three computing channels 11, 21, and 31 separately receives aircraft sensor input data, processes this data, and outputs commands to aircraft actuators. The three computing channels 11, 21, and 31 of the present invention are intended to function in a similar manner as the three computing channels 10, 20, and 30 such as is shown in FIGS. 1-2 and known in the prior art. On a particular aircraft, these computing channels may be packaged in separate line replaceable units (LRU) which are typically identified as flight control computers (FCC).

Each of the three computing channels includes a main processor 113, identified in FIG. 3 as ‘CPU 1’ and a monitor processor 114, identified in FIG. 3 as ‘CPU 2’. Monitor processor 114 is a different processor type than main processor 113, as described below. The three flight control computer channels, channel A 11, channel B 21, and channel C 31 are interconnected by a set of cross-channel data links 5A, 5B, and 5C. These cross-channel data links 5A, 5B, and 5C allow the flight control computers to share sensor input value, actuator command values, and validity data.

Refer now to FIG. 4, which shows a block diagram of a specific embodiment of my invention suitable for a computing channel, such as for example, flight control computer channel A 11 as shown in FIG. 3. Main processor 113 and dissimilar monitor processor 114 each run different machine instructions even when the two processors are executing operational flight programs (OFP) that are compiled and assembled from the same source code. Because of this processor dissimilarity, this dual processor configuration is able to detect a generic software fault such as a “processor gets lost” or an erroneous calculation. Also, since the main processor 113 is different from the monitor processor 114, different software development environments are used to compile and assemble the source code. The use of these different software development environments will allow the use of the same operating system on both processors while still maintaining object code (machine instruction) independence.

FIGS. 4 and 5 illustrate both one embodiment of my system and a method of mitigating a generic fault that occurs simultaneously on both main processor 113 and dissimilar monitor processor 114. First, an input controller 111 inputs (step 41) aircraft input data into a shared memory 112 that is accessible by either the main processor 113 or the monitor processor 114. The main processor 113 reads input data 121 from the shared memory 112, processes this data (step 42) to produce outputs, and places the resultant main processor outputs 122 back into the shared memory 112.

Next, the monitor processor 114 reads the input data 121 from the shared memory 112, processes this data (step 43) to produce outputs, and places the resultant monitor processor outputs 123 back into the shared memory 112. The main processor 113 compares (step 44) its resultant data 122 with the resultant data 123 from the monitor processor 114. If a difference between the main processor resultant data 122 and the monitor processor resultant data 123 exceeds a predetermined threshold and persists, then the main processor 113 outputs a main processor “miscompare” discrete 124.

Next, the monitor processor 114 compares its resultant data 123 with the resultant data 122 from the main processor 113. If a difference between the monitor processor resultant data 123 and the main processor resultant data 122 exceeds a predetermined threshold and persists, then the monitor processor 114 outputs a monitor processor “miscompare” discrete 125.

If either the main processor 113 or the monitor processor 114 has issued a miscompare discrete, then the affected computing channel, for example computing channel A 11, issues a “Failure A” discrete 131. The “Failure A” discrete 131 is transmitted to the other two computing channels 21 and 31 and also arms the AND gate 134 for a possible “Generic Failure” discrete 132 (step 46). The cross-channel transmission of these discretes is preferably by hardwired discrete signals, such as +28 VDC/Ground.

During normal operation, the other two computing channels 21 and 31 are performing a similar operation. If the “Failure B” discrete 141 and the “Failure C” discrete 142 are received, at AND gate 134, from the other two computing channels 21 and 31, then the “Generic Failure” discrete 132 is issued. The “Generic Failure” discrete 132 issues (step 47) a program interrupt 133 which vectors the main processor 113, in each of the computing channels, to run (step 48) a minimal “get home” software package 150. The “get home” software package 150 executes on the main processor 113 and since it has been 100% tested no further software or hardware generic faults can occur, or may in other embodiments, execute on a separate processor. In certain embodiments, the “get home” software is tested using deterministic mathematical methods.

FIG. 6 illustrates a flow chart of the software that executes in each main processor 113 and its associated monitor processor 114. The main processor 113 is powered on (step 51), hardware associated with the main processor is initialized (step 52), and the operating system, such as Integrity®, associated with the main processor is invoked (step 53) prior to normal operation. In preferred embodiments, the method of the present invention is performed concurrently with normal operation. The main processor 113 function of executing the application program (step 54), shown in FIG. 6, corresponds to the method step of the present invention of processing data (step 42), shown in FIG. 5. The main processor functions of comparing main result to monitor result (step 55) and setting the main processor miscompare discrete (step 56) correspond to the method steps of the present invention of comparing data at the main processor (step 44) and transmitting cross-channel data and arming a generic fault (step 46), respectively.

The monitor processor 114 is powered on (step 61), hardware associated with the monitor processor is initialized (step 62), and the operating system, such as VxWorks®, associated with the monitor processor is invoked (step 63) prior to normal operation. In preferred embodiments, the method of the present invention is performed concurrently with normal operation. The monitor processor 114 function of executing the application program (step 64), shown in FIG. 6, corresponds to the method step of the present invention of processing data at the monitor processor (step 43), shown in FIG. 5. The monitor processor functions of comparing monitor result to main result (step 65) and setting the monitor processor miscompare discrete (step 66) correspond to the method steps of the present invention of comparing data at the monitor processor (step 45) and transmitting cross-channel data and arming a generic fault (step 46), respectively.

FIG. 6 also illustrates the operation of running the minimal ‘get home’ software package on the main processor 113. The program interrupt 133 is received (step 71) and the minimal ‘get home’ software 150 is run (step 72) software.

Advantageously, my invention requires a total processor count of six processors running in three independent computing channels. This contrasts with the prior art, which requires a total of twelve processors running in three independent computing channels to achieve similar functionality. This is achieved by taking advantage of extremely well-tested commercially available processors that have literally billions of hours of cumulative operation in such devices as home computers

### Alternate Embodiments

Alternate embodiments may be devised without departing from the spirit or the scope of the invention.

What is claimed is:

1. A computer system capable of mitigating a generic software fault thereon, said system comprising:
(a) a computing channel including a main processor under control of a first operating system and a monitor processor under control of a second operating system , said first and second operating systems being distinct;
(b) means for providing the same inputs to said main and monitor processors, said main and monitor processors performing the same processing steps to produce output data;
(c) means for comparing said output data from said main and monitor processors to detect a software fault and for producing a generic failure discrete upon said output data from said main and monitor processors not agreeing within a predetermined threshold value; and
(d) means responsive to said comparing means determining that said output data from s aid main and monitor processors do not agree for causing execution of a fully tested software package distinct from said operating systems to mitigate any effect of the detected software fault.

2. The computer system in accordance with claim 1 wherein said system is a flight control computer on an airplane and said separate software package is a “get home” software package.

3. The system in accordance with claim 2 wherein said separate software package is executed on said main processor.

4. The system in accordance with claim 3 wherein said system is a multi-channel computer system, each of said channels comprising a main and a monitor processor, said means for providing the same inputs to said main and monitor processors comprising a shared memory, and said means for causing execution of said fully tested software package including means responsive to generic failure discretes from all of said channels.

5. A method for mitigating a generic software fault in a computer system comprising a computing channel including a main processor and a monitor processor, said main and monitor processors being under control of distinct operating systems for performing the same functions; said method comprising the steps of:
(a) inputting input data to said main and said monitor processors;
(b) processing said input data by said main and said monitor processors to produce output data from said main and said monitor processors,
(c) comparing said output data from said main and said monitor processors to detect a software fault if they do not agree within a predetermined threshold value; and
(d) executing a fully tested software package distinct from said main and said monitor operating systems responsive to detection of the software fault to mitigate any effect of the detected software fault.

6. The method in accordance with claim 5 wherein said computer system is a flight control computer system on an airplane and said software package is a “get home” software package.

7. The method of claim 6 wherein said computer system comprises a plurality of computing channels, each including a main and a monitor processor under control of distinct operating systems, said method including the main and monitor processors in each of said channels comparing output data to detect a software fault and said step of executing said fully tested software package being responsive to detection of said software fault by all of said channels.

8. A method of mitigating a generic software fault in a multi-channel flight control computer system (1) comprising a plurality of computing channels (11, 21, and 31), each channel including a main processor (113) and a monitor processor (114), said method comprising the steps of:
(a) inputting data (step 41) into a shared memory (112) of a first of said channels (11) that is accessible by either the main processor (113) or associated monitor processor (114) of said first of said channels;
(b) processing data at the main processor (step 42) by reading inputs (121) from said shared memory, computing main processor output data (122), and placing the main processor output data into said shared memory;
(c) processing data at the monitor processor (step 43) by reading inputs from said shared memory, computing monitor processor output data (123), and placing the monitor processor output data into said shared memory;
(c) comparing data at the main processor (step 44) by determining whether the main processor output data and the monitor processor output data agree with each other within a predetermined set of threshold values and outputting a main processor miscompare discrete (124) when they do not agree;
(d) comparing data at the monitor processor (step 45) by determining whether the main processor output data and the monitor processor output data agree with each other within a predetermined threshold and outputting a monitor processor miscompare discrete (125) when they do not agree and such disagreement persists;
(e) transmitting (step 46) a plurality of cross-channel failure discretes (131) to each of the other computing channels (21, 31) and arming a local generic fault discrete (132);
(f) causing a program interrupt (step 47) when the local generic fault discrete is armed and a set of corresponding cross-channel failure discretes (141, 142) are received from said plurality of other computing channels; and
(g) running (step 48) a minimal fully tested software package (150) on said main processor to mitigate the generic software fault.

9. The method in accordance with claim 8 wherein:
(a) said a minimal fully tested software package has been tested by deterministic mathematical methods.
